(19) United States
(12) Patent Application Publication
(10) Pub. No.: US 2025/0280150 A1
(43) Pub. Date: Sep. 4, 2025

(54) A METHOD AND APPARATUS FOR ENCODING/DECODING A 3D SCENE

(71) Applicant: InterDigital CE Patent Holdings, SAS, Paris (FR)

(72) Inventors: Bertrand Chupeau, Rennes (FR); Franck Thudor, Rennes (FR); Gerard Briand, Ploufragan (FR); Remy Gendrot, Montgermont (FR)

(21) Appl. No.: 18/858,122

(22) PCT Filed: Apr. 6, 2023
(86) PCT No.: PCT/EP2023/059234

§ 371 Date: Oct. 18, 2024

(30) Foreign Application Priority Data
Apr. 21, 2022 (EP) 22305591.4

(51) Int. Cl. H04N 19/597; H04N 19/54

(52) U.S. Cl. CPC H04N 19/597; H04N 19/54

(57) ABSTRACT

A method and an apparatus for reconstructing at least one sequence of volumetric frames from a data stream are provided wherein the sequence of volumetric frames is temporally resampled and/or temporally aligned to a composition time frame using 3D motion information obtained for the volumetric frames. The method comprises decoding from the data stream the at least one sequence of volumetric frames, obtaining a 3D motion information representative of a displacement in a 3D space of points of volumetric frames of the at least one sequence, and displacing points of at least one volumetric frame of the sequence to a composition time frame using the 3D motion information.

### CROSS REFERENCE TO RELATED APPLICATIONS

This application claims the priority to European Application No. 22305591.4, filed on Apr. 21, 2022, which is incorporated herein by reference in its entirety.

### 1. TECHNICAL FIELD

The present principles generally relate to the domain of three-dimensional (3D) scene and volumetric video content. The present document is also understood in the context of the encoding, the formatting and the decoding of data representative of the texture and the geometry of a 3D scene for a rendering of volumetric content on end-user devices such as mobile devices or Head-Mounted Displays (HMD).

### 2. BACKGROUND

The present section is intended to introduce the reader to various aspects of art, which may be related to various aspects of the present principles that are described and/or claimed below. This discussion is believed to be helpful in providing the reader with background information to facilitate a better understanding of the various aspects of the present principles. Accordingly, it should be understood that these statements are to be read in this light, and not as admissions of prior art. Recently there has been a growth of available large field-of-view content (up to) 360°. Such content is potentially not fully visible by a user watching the content on immersive display devices such as Head Mounted Displays, smart glasses, PC screens, tablets, smartphones and the like. That means that at a given moment, a user may only be viewing a part of the content. However, a user can typically navigate within the content by various means such as head movement, mouse movement, touch screen, voice and the like. It is typically desirable to encode and decode this content.

Immersive video, also called 360° flat video, allows the user to watch all around himself through rotations of his head around a still point of view. Rotations only allow a 3 Degrees of Freedom (3DoF) experience. Even if 3DoF video is sufficient for a first omnidirectional video experience, for example using a Head-Mounted Display device (HMD), 3DoF video may quickly become frustrating for the viewer who would expect more freedom, for example by experiencing parallax.

In addition, 3DoF may also induce dizziness because of a user never only rotates his head but also translates his head in three directions, translations which are not reproduced in 3DoF video experiences.

A large field-of-view content may be, among others, a three-dimension computer graphic imagery scene (3D CGI scene), a point cloud or an immersive video. Many terms might be used to design such immersive videos: Virtual Reality (VR), 360, panoramic, 4π steradians, immersive, omnidirectional or large field of view for example.

Volumetric video (also known as 6 Degrees of Freedom (6DoF) video) is an alternative to 3DoF video. When watching a 6DoF video, in addition to rotations, the user can also translate his head, and even his body, within the watched content and experience parallax and even volumes. Such videos considerably increase the feeling of immersion and the perception of the scene depth and prevent from dizziness by providing consistent visual feedback during head translations. The content is created by the means of dedicated sensors allowing the simultaneous recording of color and depth of the scene of interest. The use of rig of color cameras combined with photogrammetry techniques is a way to perform such a recording, even if technical difficulties remain.

While 3DoF videos comprise a sequence of images resulting from the un-mapping of texture images (e.g. spherical images encoded according to latitude/longitude projection mapping or equirectangular projection mapping), 6DoF video frames embed information from several points of views. They can be viewed as a temporal series of point clouds resulting from a three-dimension capture. Two kinds of volumetric videos may be considered depending on the viewing conditions. A first one (i.e. complete 6DoF) allows a complete free navigation within the video content whereas a second one (aka. 3DoF+) restricts the user viewing space to a limited volume called viewing bounding box, allowing limited translation of the head and parallax experience. This second context is a valuable trade-off between free navigation and passive viewing conditions of a seated audience member.

When a 3D scene comprises a plurality of objects encoded in separate sub-streams which can be temporally unaligned or encoded at different frames rates, artefacts can be present when rendering the reconstructed 3D scene from the sub-streams. In a similar way, when a sequence of volumetric frames is to be rendered at a frame rate that is different from the frame rate at which the sequence is encoded, some artefacts can be present in the reconstructed sequence of volumetric frames rendered at the desired frame rate.

### 3. Summary

The following presents a simplified summary of the present principles to provide a basic understanding of some aspects of the present principles. This summary is not an extensive overview of the present principles. It is not intended to identify key or critical elements of the present principles. The following summary merely presents some aspects of the present principles in a simplified form as a prelude to the more detailed description provided below.

According to an aspect of the present principles, a method and an apparatus for reconstructing at least one sequence of volumetric frames from a data stream are provided wherein the sequence of volumetric frames is temporally resampled and/or temporally aligned to a composition time frame using 3D motion information obtained for the volumetric frames.

According to an aspect of the present principles, a method for reconstructing at least one sequence of volumetric frames from a data stream is provided wherein the method includes decoding from the data stream the at least one sequence of volumetric frames, obtaining a 3D motion information representative of a displacement in a 3D space of points of volumetric frames of the at least one sequence, displacing points of at least one volumetric frame of the sequence to a composition time frame using the 3D motion information.

According to another aspect of the present principles, an apparatus comprising one or more processors configured to reconstruct at least one sequence of volumetric frames from a data stream is provided wherein the one or more processors are configured to decode from the data stream the at least one sequence of volumetric frames, obtain a 3D motion information representative of a displacement in a 3D space of points of volumetric frames of the at least one sequence, displace points of at least one volumetric frame of the sequence to a composition time frame using the 3D motion information.

According to another aspect, a method or an apparatus configured for reconstructing at least one sequence of volumetric frames is provided wherein the reconstructing comprises decoding from the data stream the at least one sequence of volumetric frames, obtaining a 3D motion information representative of a displacement in a 3D space of points of volumetric frames of the at least one sequence, and resampling the at least one sequence of volumetric frames at a frame rate different from the frame rate used at encoding, wherein the resampling uses the 3D motion information.

According to another aspect, a method for encoding at least one sequence of volumetric frames representative of a 3D scene is provided. The method comprises obtaining, for at least one volumetric frame of the sequence, a patch-atlas based representation, obtaining a 3D motion information representative of a displacement in a 3D space of de-projected samples of the patch-atlas based representation between two volumetric frames of the sequence, encoding in a data stream the patch-atlas based representation and the 3D motion information.

According to another aspect, an apparatus comprising one or more processors configured to encode at least one sequence of volumetric frames is provided, wherein the one or more processors are further configured to obtain, for at least one volumetric frame of the sequence, a patch-atlas based representation, obtain a 3D motion information representative of a displacement in a 3D space of de-projected samples of the patch-atlas based representation between two volumetric frames of the sequence, encode in a data stream the patch-atlas based representation and the 3D motion information.

According to an embodiment, the composition time frame is different from a time frame encoded in the data stream. According to another embodiment, the at least one sequence of volumetric frames is representative of a 3D scene comprising at least two objects encoded in separate sub-streams of the data stream. In a further embodiment, displacing points of the at least one volumetric frame comprises motion-compensating the decoded volumetric frame using the 3D motion information. In another embodiment, each one of the at least two objects of the 3D scene is encoded as a sequence of volumetric frames.

In some embodiments, the 3D motion information is encoded as 3D motion attribute video sub-stream. In other embodiments, the 3D motion information is encoded as metadata associated to at least one patch of a patch-atlas based representation of the at least one sequence of the volumetric frames.

In some embodiments, at least one syntax element indicating a presence of 3D motion information is encoded in the data stream.

One or more embodiments also provide a computer program comprising instructions which when executed by one or more processors cause the one or more processors to perform the encoding method or decoding method according to any of the embodiments described herein. One or more of the present embodiments also provide a computer readable storage medium having stored thereon instructions for encoding or decoding sequences of volumetric frames according to the methods described herein. One or more embodiments also provide a computer readable storage medium having stored thereon a bitstream generated according to the methods described herein. One or more embodiments also provide a method and apparatus for transmitting or receiving the bitstream generated according to the methods described herein.

### 4. BRIEF DESCRIPTION OF DRAWINGS

The present disclosure will be better understood, and other specific features and advantages will emerge upon reading the following description, the description making reference to the annexed drawings wherein:

FIG. 1 shows a three-dimension (3D) model of an object and points of a point cloud corresponding to the 3D model, according to a non-limiting embodiment of the present principles;

FIG. 2 shows a non-limitative example of the encoding, transmission and decoding of data representative of a sequence of 3D scenes, according to a non-limiting embodiment of the present principles;

FIG. 3 shows an example architecture of a device which may be configured to implement a method described in relation with FIGS. 8-18, according to a non-limiting embodiment of the present principles;

FIG. 4 shows an example of an embodiment of the syntax of a data stream transmitted over a packet-based transmission protocol, according to a non-limiting embodiment of the present principles;

FIG. 5 illustrates a spherical projection from a central point of view, according to a non-limiting embodiment of the present principles;

FIG. 6 shows an example of an atlas comprising texture information of the points of a 3D scene, according to a non-limiting embodiment of the present principles;

FIG. 7 shows an example of an atlas comprising depth information of the points of the 3D scene of FIG. 6, according to a non-limiting embodiment of the present principles;

FIG. 8 shows an example of a segmentation map into objects provided for one of MIV test sequences;

FIG. 9 shows an example of a 3D scene composed of 4 objects;

FIG. 10 shows an example of temporally unaligned object-based MIV sub-streams;

FIG. 11 shows an example of a method for encoding a 3D scene according to an embodiment;

FIG. 12 shows an example of a method for decoding a 3D scene, according to an embodiment;

FIG. 13 shows an example of 3D motion estimation of point cloud samples;

FIG. 14 shows an example of a method for reconstructing a 3D scene having a plurality of 3D objects encoded at different frame-rates, according to an embodiment;

FIG. 15 shows an example of an MIV bitstream with 3D motion attribute video, according to an embodiment;

FIG. 16 shows an example of a point-based (a) and patch-based (b) 3D motion compensation;

FIG. 17 shows an example of an object-based encoding method according to an embodiment;

FIG. 18 shows an example of an object-based decoding method according to an embodiment.

### 5. DETAILED DESCRIPTION OF EMBODIMENTS

The present principles will be described more fully hereinafter with reference to the accompanying figures, in which examples of the present principles are shown. The present principles may, however, be embodied in many alternate forms and should not be construed as limited to the examples set forth herein. Accordingly, while the present principles are susceptible to various modifications and alternative forms, specific examples thereof are shown by way of examples in the drawings and will herein be described in detail. It should be understood, however, that there is no intent to limit the present principles to the particular forms disclosed, but on the contrary, the disclosure is to cover all modifications, equivalents, and alternatives falling within the spirit and scope of the present principles as defined by the claims.

The terminology used herein is for the purpose of describing particular examples only and is not intended to be limiting of the present principles. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to other element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the present principles.

Although some of the diagrams include arrows on communication paths to show a primary direction of communication, it is to be understood that communication may occur in the opposite direction to the depicted arrows.

Some examples are described with regard to block diagrams and operational flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

Reference herein to “in accordance with an example” or “in an example” means that a particular feature, structure, or characteristic described in connection with the example can be included in at least one implementation of the present principles. The appearances of the phrase in accordance with an example” or “in an example” in various places in the specification are not necessarily all referring to the same example, nor are separate or alternative examples necessarily mutually exclusive of other examples.

Reference numerals appearing in the claims are by way of illustration only and shall have no limiting effect on the scope of the claims. While not explicitly described, the present examples and variants may be employed in any combination or sub-combination.

The MIV standard (ISO/IEC 23090-12:2022 MPEG Immersive Video) allows for carrying the volumetric information as a combination of 2D patches stored in atlas frames which are encoded making use of regular 2D video codecs (typically HEVC or VVC standards). Each patch corresponds to the projection of a subpart of a 3D input scene, with its geometry, various attributes and associated camera parameters. So far, depending on the MIV profile, the following atlas components can be present in a bitstream: geometry (depth map), occupancy (pixel validity binary map), colour attribute and transparency attribute.

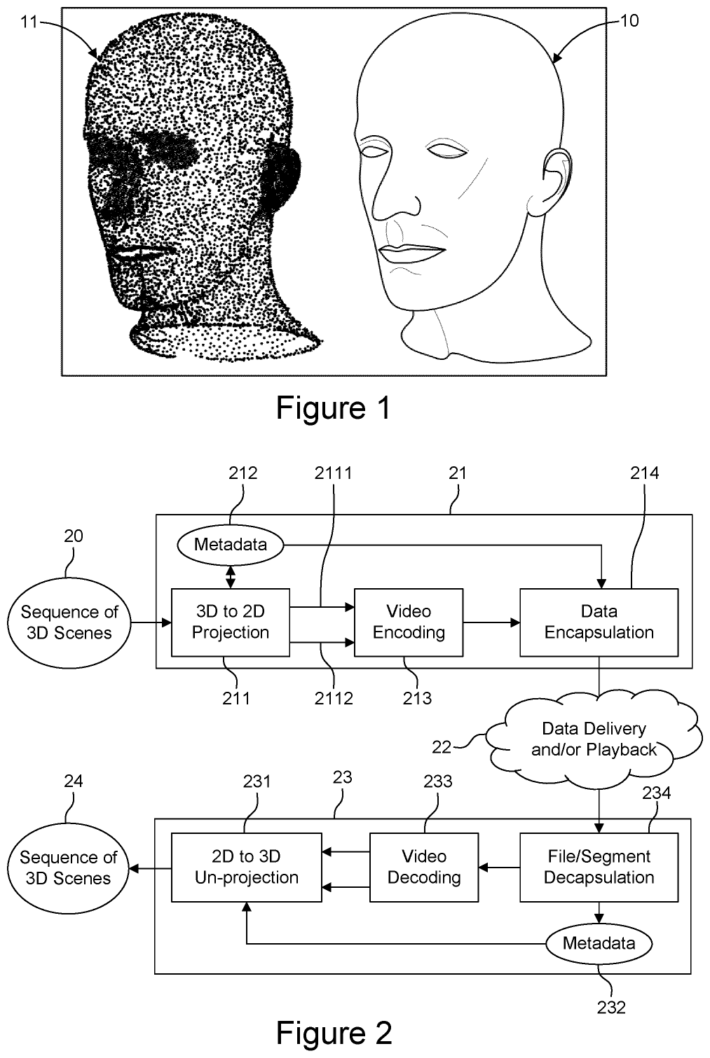

FIG. 1 shows a three-dimension (3D) model 10 of an object and points of a point cloud 11 corresponding to 3D model 10. 3D model 10 and the point cloud 11 may for example correspond to a possible 3D representation of an object of the 3D scene comprising other objects. Model 10 may be a 3D mesh representation and points of point cloud 11 may be the vertices of the mesh. Points of point cloud 11 may also be points spread on the surface of faces of the mesh. Model 10 may also be represented as a splatted version of point cloud 11, the surface of model 10 being created by splatting the points of the point cloud 11. Model 10 may be represented by a lot of different representations such as voxels or splines. FIG. 1 illustrates the fact that a point cloud may be defined with a surface representation of a 3D object and that a surface representation of a 3D object may be generated from a point of cloud. As used herein, projecting points of a 3D object (by extension points of a 3D scene) onto an image is equivalent to projecting any representation of this 3D object, for example a point cloud, a mesh, a spline model or a voxel model.

A point cloud may be represented in memory, for instance, as a vector-based structure, wherein each point has its own coordinates in the frame of reference of a viewpoint (e.g. three-dimensional coordinates XYZ, or a solid angle and a distance (also called depth) from/to the viewpoint) and one or more attributes, also called component. An example of component is the color component that may be expressed in various color spaces, for example RGB (Red, Green and Blue) or YUV (Y being the luma component and UV two chrominance components). The point cloud is a representation of a 3D scene comprising objects. The 3D scene may be seen from a given viewpoint or a range of viewpoints. The point cloud may be obtained by many ways, e.g.: from a capture of a real object shot by a rig of cameras, optionally complemented by depth active sensing device; from a capture of a virtual/synthetic object shot by a rig of virtual cameras in a modelling tool; or from a mix of both real and virtual objects.

FIG. 2 shows a non-limitative example of the encoding, transmission and decoding of data representative of a sequence of 3D scenes. The encoding format that may be, for example and at the same time, compatible for 3DoF, 3DoF+ and 6DoF decoding.

A sequence of 3D scenes 20 is obtained. As a sequence of pictures is a 2D video, a sequence of 3D scenes is a 3D (also called volumetric) video. A sequence of 3D scenes may be provided to a volumetric video rendering device for a 3DoF, 3Dof+ or 6DoF rendering and displaying.

Sequence of 3D scenes 20 is provided to an encoder 21. The encoder 21 takes one 3D scenes or a sequence of 3D scenes as input and provides a bit stream representative of the input. The bit stream may be stored in a memory 22 and/or on an electronic data medium and may be transmitted over a network 22. The bit stream representative of a sequence of 3D scenes may be read from a memory 22 and/or received from a network 22 by a decoder 23. Decoder 23 is inputted by said bit stream and provides a sequence of 3D scenes, for instance in a point cloud format.

Encoder 21 may comprise several circuits implementing several steps. In a first step, encoder 21 projects each 3D scene onto at least one 2D picture. 3D projection is any method of mapping three-dimensional points to a two-dimensional plane. As most current methods for displaying graphical data are based on planar (pixel information from several bit planes) two-dimensional media, the use of this type of projection is widespread, especially in computer graphics, engineering and drafting. Projection circuit 211 provides at least one two-dimensional frame 2111 for a 3D scene of sequence 20. Frame 2111 comprises color information and depth information representative of the 3D scene projected onto frame 2111. In a variant, color information and depth information are encoded in two separate frames 2111 and 2112.

Metadata 212 are used and updated by projection circuit 211. Metadata 212 comprise information about the projection operation (e.g. projection parameters) and about the way color and depth information is organized within frames 2111 and 2112 as described in relation to FIGS. 5 to 7.

A video encoding circuit 213 encodes sequence of frames 2111 and 2112 as a video. Pictures of a 3D scene 2111 and 2112 (or a sequence of pictures of the 3D scene) is encoded in a stream by video encoder 213. Then video data and metadata 212 are encapsulated in a data stream by a data encapsulation circuit 214.

Encoder 213 is for example compliant with an encoder such as an HEVC or VVC encoder.

The data stream is stored in a memory that is accessible, for example through a network 22, by a decoder 23. Decoder 23 comprises different circuits implementing different steps of the decoding. Decoder 23 takes a data stream generated by an encoder 21 as an input and provides a sequence of 3D scenes 24 to be rendered and displayed by a volumetric video display device, like a Head-Mounted Device (HMD). Decoder 23 obtains the stream from a source 22. For example, source 22 belongs to a set comprising: a local memory, e.g. a video memory or a RAM (or Random-Access Memory), a flash memory, a ROM (or Read Only Memory), a hard disk; a storage interface, e.g. an interface with a mass storage, a RAM, a flash memory, a ROM, an optical disc or a magnetic support; a communication interface, e.g. a wireline interface (for example a bus interface, a wide area network interface, a local area network interface) or a wireless interface (such as a IEEE 802.11 interface or a Bluetooth® interface); and a user interface such as a Graphical User Interface enabling a user to input data.

Decoder 23 comprises a circuit 234 for extract data encoded in the data stream. Circuit 234 takes a data stream as input and provides metadata 232 corresponding to metadata 212 encoded in the stream and a two-dimensional video. The video is decoded by a video decoder 233 which provides a sequence of frames. Decoded frames comprise color and depth information. In a variant, video decoder 233 provides two sequences of frames, one comprising color information, the other comprising depth information. A circuit 231 uses metadata 232 to un-project color and depth information from decoded frames to provide a sequence of 3D scenes 24. Sequence of 3D scenes 24 corresponds to sequence of 3D scenes 20, with a possible loss of precision related to the encoding as a 2D video and to the video compression.

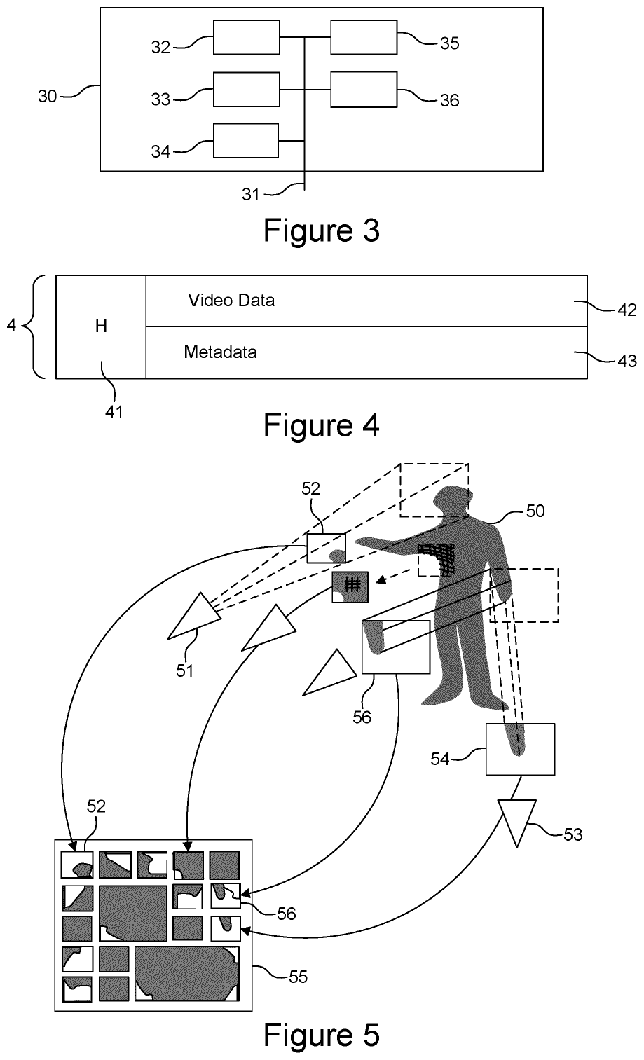

FIG. 3 shows an example architecture of a device 30 which may be configured to implement a method according to any one of the embodiments described below. Encoder 21 and/or decoder 23 of FIG. 2 may implement this architecture. Alternatively, each circuit of encoder 21 and/or decoder 23 may be a device according to the architecture of FIG. 3, linked together, for instance, via their bus 31 and/or via I/O interface 36.

Device 30 comprises following elements that are linked together by a data and address bus 31: a microprocessor 32 (or CPU), which is, for example, a DSP (or Digital Signal Processor); a ROM (or Read Only Memory) 33; a RAM (or Random Access Memory) 34; a storage interface 35; an I/O interface 36 for reception of data to transmit, from an application; and a power supply, e.g. a battery.

In accordance with an example, the power supply is external to the device. In each of mentioned memory, the word«register»used in the specification may correspond to area of small capacity (some bits) or to very large area (e.g. a whole program or large amount of received or decoded data). The ROM 33 comprises at least a program and parameters. The ROM 33 may store algorithms and instructions to perform techniques in accordance with present principles. When switched on, the CPU 32 uploads the program in the RAM and executes the corresponding instructions.

The RAM 34 comprises, in a register, the program executed by the CPU 32 and uploaded after switch-on of the device 30, input data in a register, intermediate data in different states of the method in a register, and other variables used for the execution of the method in a register.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

In accordance with examples, the device 30 is configured to implement a method according to any one of the embodiments described below, and belongs to a set comprising at least one of: a mobile device; a communication device; a game device; a tablet (or tablet computer); a laptop; a still picture camera; a video camera; an encoding chip; or a server (e.g. a broadcast server, a video-on-demand server or a web server).

FIG. 4 shows an example of an embodiment of the syntax of a stream when the data are transmitted over a packet-based transmission protocol. FIG. 4 shows an example structure 4 of a volumetric video stream. The structure consists in a container which organizes the stream in independent elements of syntax. The structure may comprise a header part 41 which is a set of data common to every syntax elements of the stream. For example, the header part comprises some of metadata about syntax elements, describing the nature and the role of each of them. The header part may also comprise a part of metadata 212 of FIG. 2, for instance the coordinates of a central point of view used for projecting points of a 3D scene onto frames 2111 and 2112. The structure comprises a payload comprising an element of syntax 42 and at least one element of syntax 43. Syntax element 42 comprises data representative of the color and depth frames. Images may have been compressed according to a video compression method.

Element of syntax 43 is a part of the payload of the data stream and may comprise metadata about how frames of element of syntax 42 are encoded, for instance parameters used for projecting and packing points of a 3D scene onto frames. Such metadata may be associated with each frame of the video or to group of frames (also known as Group of Pictures (GoP) in video compression standards).

FIG. 5 illustrates the patch atlas approach with an example of 4 projection centers. 3D scene 50 comprises a character. For instance, center of projection 51 is a perspective camera and camera 53 is an orthographic camera. Cameras may also be omnidirectional cameras with, for instance a spherical mapping (e.g. Equi-Rectangular mapping) or a cube mapping. The 3D points of the 3D scene are projected onto the 2D planes associated with virtual cameras located at the projection centers, according to a projection operation described in projection data of metadata. In the example of FIG. 5, projection 51 of the points captured by a camera is mapped onto patch 52 according to a perspective mapping and projection of the points captured by camera 53 is mapped onto patch 54 according to an orthographic mapping.

The clustering of the projected pixels yields a multiplicity of 2D patches, which are packed in a rectangular atlas 55. The organization of patches within the atlas defines the atlas layout. In an embodiment, two atlases with identical layout: one for texture (i.e. color) information and one for depth information. Two patches captured by a same camera or by two distinct cameras may comprise information representative of a same part of the 3D scene, like, for instance patches 54 and 56.

The packing operation produces a patch data for each generated patch. A patch data comprises a reference to a projection data (e.g. an index in a table of projection data or a pointer (i.e. address in memory or in a data stream) to a projection data) and information describing the location and the size of the patch within the atlas (e.g. top left corner coordinates, size and width in pixels). Patch data items are added to metadata to be encapsulated in the data stream in association with the compressed data of the one or two atlases.

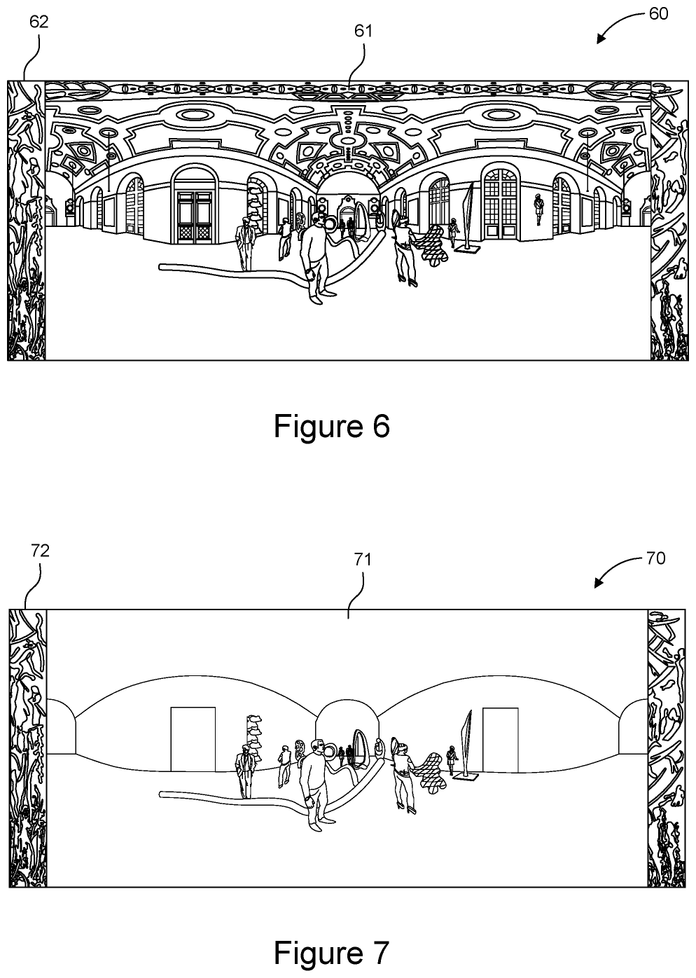

FIG. 6 shows an example of an atlas 60 comprising texture information (e.g. RGB data or YUV data) of the points of a 3D scene, according to a non-limiting embodiment of the present principles. As explained in relation to FIG. 5, an atlas is an image packing patches, a patch being a picture obtained by projecting a part of the points of the 3D scene.

In the example of FIG. 6, atlas 60 comprises a first part 61 comprising the texture information of the points of the 3D scene that are visible from a point of view and one or more second parts 62. The texture information of first part 61 may for example be obtained according to an equirectangular projection mapping, an equirectangular projection mapping being an example of spherical projection mapping. In the example of FIG. 6, the second parts 62 are arranged at the left and right borders of first part 61 but the second parts may be arranged differently. Second parts 62 comprise texture information of parts of the 3D scene that are complementary to the part visible from the point of view. The second parts may be obtained by removing from the 3D scene the points that are visible from the first viewpoint (the texture of which being stored in the first part) and by projecting the remaining points according to the same point of view. The latter process may be reiterated iteratively to obtain at each time the hidden parts of the 3D scene. According to a variant, the second parts may be obtained by removing from the 3D scene the points that are visible from the point of view, for example a central point of view, (the texture of which being stored in the first part) and by projecting the remaining points according to a point of view different from the first point of view, for example from one or more second point of view of a space of view centred onto the central point of view (e.g. the viewing space of a 3DoF rendering).

First part 61 may be seen as a first large texture patch (corresponding to a first part of the 3D scene) and the second parts 62 comprises smaller textures patches (corresponding to second parts of the 3D scene that are complementary to the first part). Such an atlas has the advantage to be compatible at the same time with 3DoF rendering (when rendering only first part 61) and with 3DoF+/6DoF rendering.

FIG. 7 shows an example of an atlas 70 comprising the depth information of the points of the 3D scene of FIG. 6, according to a non-limiting embodiment of the present principles. Atlas 70 may be seen as the depth image corresponding to texture image 60 of FIG. 6.

Atlas 70 comprises a first part 71 comprising the depth information of the points of the 3D scene that are visible from the central point of view and one or more second parts 72. Atlas 70 may be obtained in a same way as atlas 60 but contains the depth information associated with the points of the 3D scene instead of the texture information.

For 3DoF rendering of the 3D scene, only one point of view, typically the central point of view, is considered. The user may rotate his head in three degrees of freedom around the first point of view to watch various parts of the 3D scene, but the user cannot move this unique point of view. Points of the scene to be encoded are points which are visible from this unique point of view, and only the texture information is needed to be encoded/decoded for the 3DoF rendering. There is no need to encode points of the scene that are not visible from this unique point of view for a 3DoF rendering as the user cannot access to them.

With regard to 6DoF rendering, the user may move the viewpoint everywhere in the scene. In this case, it is required to encode every point (depth and texture) of the scene in the bitstream as every point is potentially accessible by a user who can move his/her point of view. At the encoding stage, there is no means to know, a priori, from which point of view the user will observe the 3D scene.

With regard to 3DoF+ rendering, the user may move the point of view within a limited space around a central point of view. This enables to experience parallax. Data representative of the part of the scene visible from any point of the space of view is to be encoded into the stream, including the data representative of the 3D scene visible according to the central point of view (i.e. first parts 61 and 71). The size and shape of the space of view may for example be decided and determined at the encoding step and encoded in the bitstream. The decoder may obtain this information from the bitstream and the renderer limits the space of view to the space determined by the obtained information. According to another example, the renderer determines the space of view according to hardware constraints, for example in relation to capabilities of the sensor(s) that detects the movements of the user. In such a case, if, at the encoding phase, a point visible from a point within the space of view of the renderer has not been encoded in the bitstream, this point will not be rendered. According to a further example, data (e.g. texture and/or geometry) representative of every point of the 3D scene is encoded in the stream without considering the rendering space of view. To optimize the size of the stream, only a subset of the points of the scene may be encoded, for instance the subset of points that may be seen according to a rendering space of view.

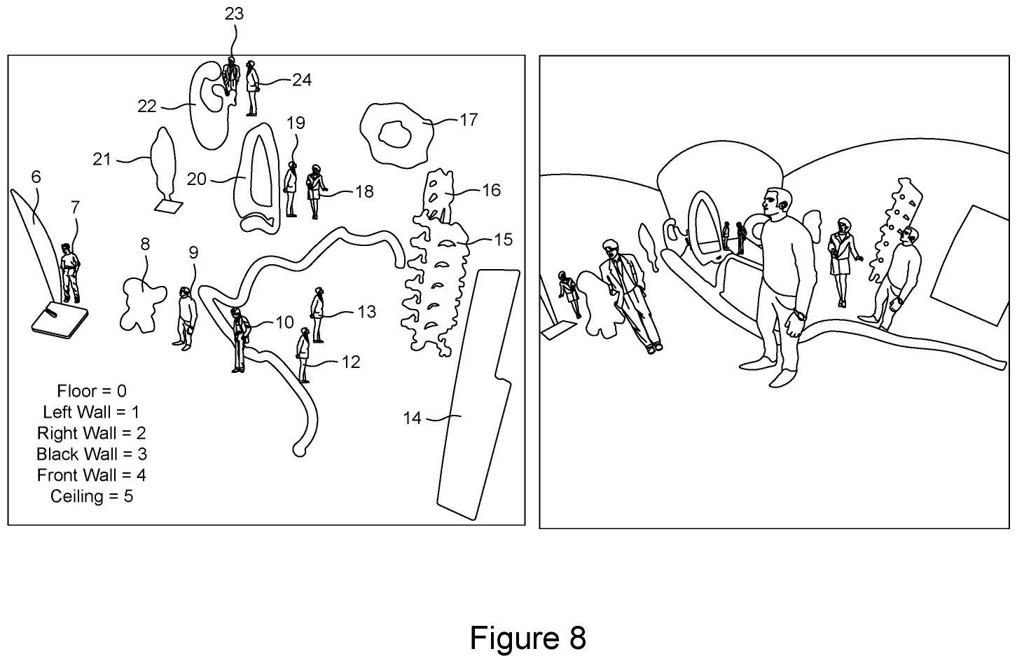

The MIV standard offers a lot of flexibility to organize the patches into multiple atlases, and/or multiple tiles within each atlas. Moreover, there is a signalling mechanism to assign each patch to a unique object ID, so-called entity ID, and therefore enable at decoder side the filtering of selected objects for partial reconstruction. FIG. 8 depicts a segmentation into 25 objects provided on one of the MIV test sequences (W. Cochran, B. Salahieh, J. Boyce, F. Yeung, “Object Maps for Technicolor Museum Sequence”, ISO/IEC JTC1/SC29/WG11 m52474, January 2020).

It is therefore possible to place the patches belonging to a given object, identified by its ID, into separate atlases, or separate tiles within an atlas. Then the geometry/occupancy/attributes patch atlas components corresponding to each object can be independently encoded, in separate video bitstreams or video tile sub-bitstreams (HEVC MCTS or VVC subpictures), and streamed in separate video tracks.

### Temporal (Un) Alignment

The first edition of MIV enforces that all metadata sub-bitstreams and video sub-bitstreams making the MIV bitstream are temporally aligned. However, the use cases and requirements for MIV second edition (“Use cases and requirements for MIV. Edition-2”, ISO/IEC JTC 1/SC 29/WG 2 N00157, January 2022) open the door to object-based encoding with different temporal sampling (frame rate) per object, and possibly unalignment:
7. The edition-2 of the specification shall enable handling of heterogenous object-specific parameters (e.g. temporal sampling, duration, atlas sizes, and non-Lambertian characteristics) at the MIV bitstream level.
18. The edition-2 of the specification shall enable composition of multiple MIV bitstreams into a single MIV bitstream.
19. The edition-2 of the specification shall maintain/enhance support for independent object-level encoding and decoding in the bitstream.

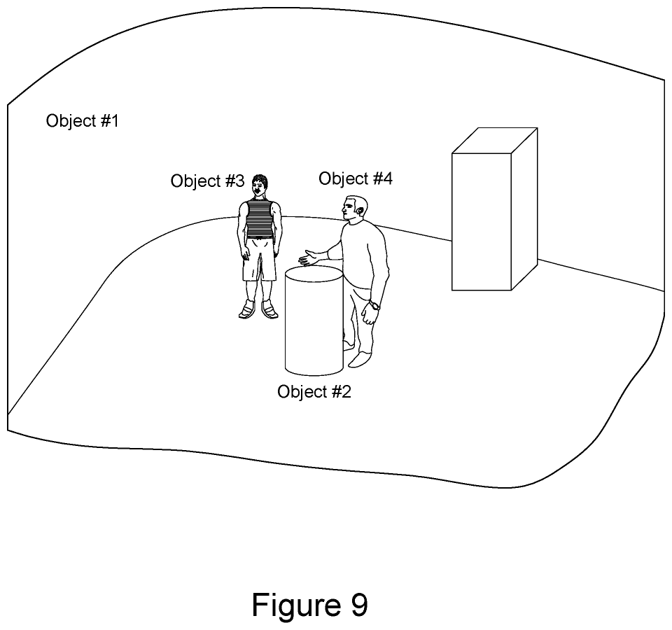

It is considered herein that a volumetric 3D scene has been generated by composition of multiple 3D sources, either captured by camera arrays or computer generated, and is represented and compressed on a per-object basis by an MIV-compliant encoder, that is with one independently decodable sub-bitstream per object, each consisting of its own atlas metadata, camera parameters and video sub-bitstreams. An example of such a 3D scene is depicted in FIG. 9, wherein 4 objects are shown.

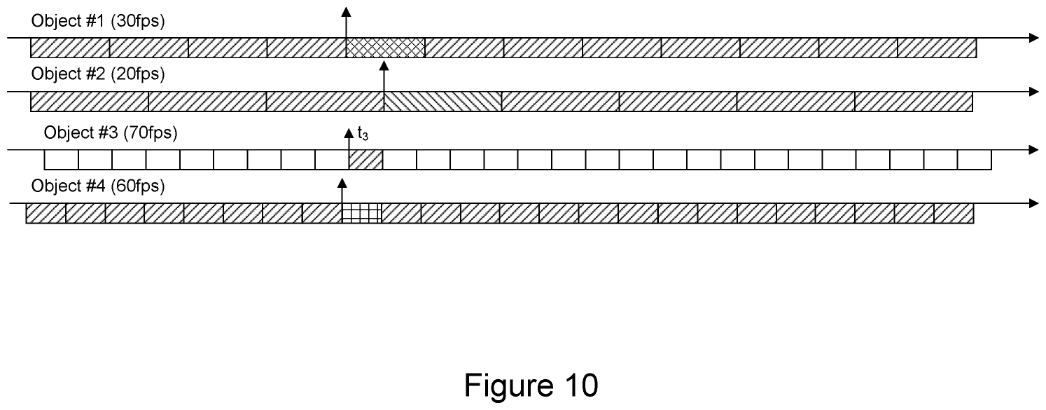

Suppose that the constraint of all object sub-bitstreams being temporally aligned is relaxed, because the different objects originate from different acquisition devices, not synchronized and running at different frame rates. An example of a result in terms of (un) alignment of the bitstream “composition units” may be illustrated by FIG. 10.

On the example illustrated by FIG. 10, it is possible to reconstruct the 3D scene parts corresponding to each four objects, but such scene parts are not synchronized, and a complete 3D scene representation at a given common output time is not straightforward to recover. On FIG. 10, the factorization of the object bitstreams into partitions associated to a given output time-so called “composition units”—, for the reconstruction of the volumetric frame at a given time instance, is depicted. For a given output time t₃ in the bitstream of object #3, the 3 closest composition units of the three other objects are highlighted (darker grey areas).

For the temporal alignment, the timeline of the object with highest frame rate could be selected as the reference timeline (#3 at 70 fps in FIG. 10) and the composition unit in each object bitstream that is closest to the selected output time (here t₃) could be gathered. This would yield however judder artefacts in the reconstructed 3D scene, all the more annoying as objects or cameras move faster.

According to an aspect of the principles presented herein, a 3D scene reconstruction method is provided wherein an accurate temporal alignment of the various object components of the 3D scene is provided.

In an embodiment, a scene composed of temporally aligned object sub-bitstreams but sampled at different frame rates could also be considered. The problem arises of performing an accurate temporal up sampling of the objects with lowest frame rates to the highest frame rate at reconstruction side, as it is well known that simple frame repetition yields judder artefacts on moving objects.

An aspect of the present principles relates to the transmission of a dynamic 3D scene, ingested as a multi-view plus depth (MVD) representation by a volumetric video encoder—for example an MIV encoder—and composed of multiple objects, transmitted in independently encoded sub-bitstreams, temporally unaligned. According to the present principles, additional 3D motion information is transmitted along with the object's sub-bitstreams, enabling an accurate 3D motion compensation when temporally aligning all object scene parts at reconstruction side.

In an embodiment, the 3D motion information can be transmitted in the form of an additional V3C “attribute” video stream.

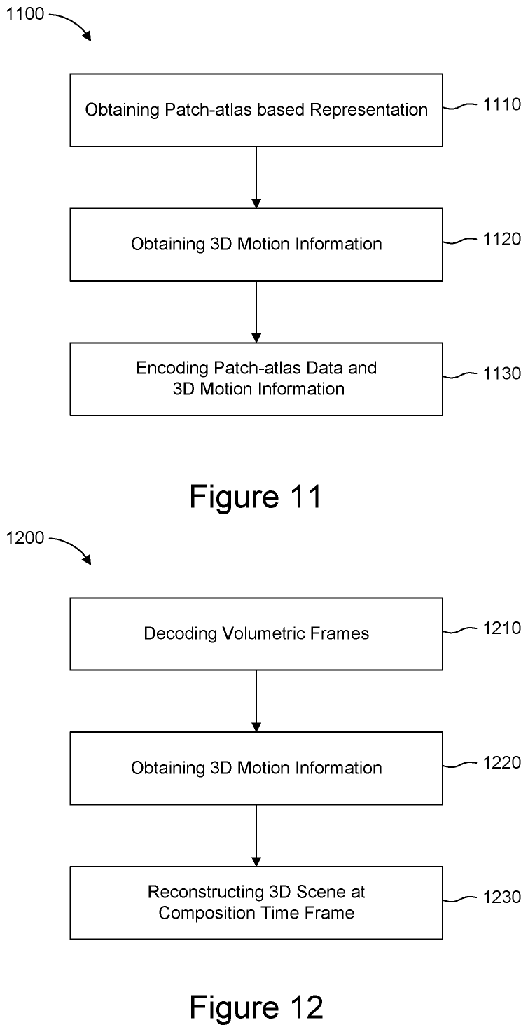

A method 1100 for encoding a 3D scene according to an embodiment is provided in FIG. 11. In an embodiment, the 3D scene comprises a plurality of 3D objects encoded in different sub-streams. In a variant, each object is encoded as a sequence of volumetric frames. In this embodiment, the following steps are performed at the encoder side for each object or sequence of volumetric frames. In another embodiment, the whole 3D scene is encoded as one sequence of volumetric frames (no object segmentation of the scene is considered).

At 1110, a patch-atlas based representation is obtained, i.e. generated, for the considered object or sequence of volumetric frames, for instance as explained above in relation with FIGS. 5-7. A patch-atlas based representation is generated for each frame of the sequence of volumetric frames representative of the object or of the 3D scene.

At 1120, 3D motion information is obtained for at least one volumetric frame of the sequence. The 3D motion information is representative of a displacement in the 3D space of de-projected samples of the patch-atlas based representation between two volumetric frames of the sequence. Therefore, the atlas samples of the volumetric frames are de-projected to their 3D positions in the 3D space and the 3D motion vector of each de-projected 3D sample is estimated. In a variant, a parameterized motion model can also be estimated per patch from the estimated 3D motion vector.

At 1130, patch-atlas data and 3D motion information are encoded for each sequence, for instance in an MIV sub-stream. The 3D motion information can be encoded either as a 3D motion attribute video stream or as 3D motion parameters per patch. The MIV bitstream is thus composed of the MIV object sub-bitstreams, with additional 3D motion information.

A method 1200 for decoding a 3D scene according to an embodiment is provided in FIG. 12. For instance, when the 3D scene comprises a plurality of 3D objects encoded in different sub-streams, the following steps are performed at the decoder and reconstruction side for each object. In an embodiment, each object is represented as a sequence of volumetric frames. Thus, the 3D scene is encoded with one or more sequence of volumetric frames. In another embodiment, the whole 3D scene is encoded as one sequence of volumetric frames. At 1210, the sequence of volumetric frames is decoded from a data stream, for instance using an MIV decoding process when the data stream conforms with the MIV standard, the partial 3D scene point cloud is reconstructed. Thus, in this embodiment, a patch-atlas based representation is decoded for each volumetric frames of the sequence.

At 1220, 3D motion information is obtained wherein the 3D motion information is representative of displacements of 3D points of the reconstructed point cloud in the 3D space. In an embodiment, the 3D motion information is decoded from the sub-streams. In another embodiment, the 3D motion information can be estimated from the reconstructed 3D scene.

At 1230, the 3D scene is reconstructed at a composition time frame using the 3D motion information. According to the present principles, when the 3D scene is encoded using a plurality of sub-streams respectively encoded an object of the 3D scene, and when the sub-streams are not temporally aligned, the present principles allow aligning the reconstructed point cloud sequences to a common timeline, making use of 3D motion compensated interpolation techniques. This allows to align the reconstructed volumetric frames at a time frame for which no data was encoded in the sub-stream. In other words, the composition time frame is different from a time frame encoded in the data stream.

Another embodiment according to which the volumetric scene is considered without object segmentation (the scene as a whole is a single object), according to the present principles, the volumetric sequence is temporally resampled at a different frame rate through high quality-3D motion compensated-frame rate conversions. The volumetric sequence it thus temporally resampled at a frame rate different from the frame rate used at encoding.

### 3D Motion Estimation

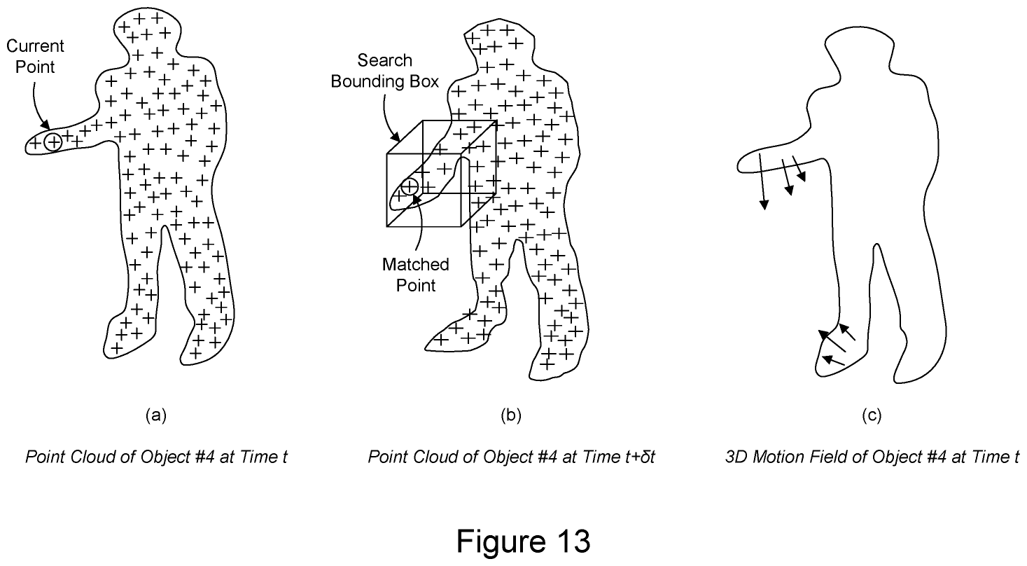

The 3D motion field of an object point cloud is illustrated in FIG. 13. If a point cloud sample is at position (X, Y,Z) at time t in the scene reference coordinate system, and at position (X+δX, Y+δY, Z+8Z) at time t+δt, its 3D motion vector is equal to (δX/δt, δY/δt, δZ/δt), expressed in scene units per time unit. State-of-art 3D techniques for estimating the 3D motion of point clouds can be used here. The size of the search neighbourhood, the similarity metrics, the searching strategy may vary but all the algorithms share the same paradigm: for each point in the source point cloud, find the best (most similar) matching point in the target neighbour point cloud. This is schematically illustrated in FIG. 13, where it is depicted from left to right: a) a given 3D sample of the point cloud at time t, b) the best matching point within the search bounding box at time t+δt, and c) the 3D motion field for the whole object, one forearm and one foot of which are moving.

In an embodiment, the 3D motion field at time t is estimated in-between the current point cloud frame and the next point cloud frame. In another embodiment, the 3D motion field at time t is estimated in-between the current point cloud frame and the previous point cloud frame. In a further other embodiment, the 3D motion field at time t is the average of the two previous estimations. In all embodiments the 3D motion values are normalized in scene units (e.g. meters) per time units (e.g. seconds) to be independent of the spatial and temporal resolution of the current object.

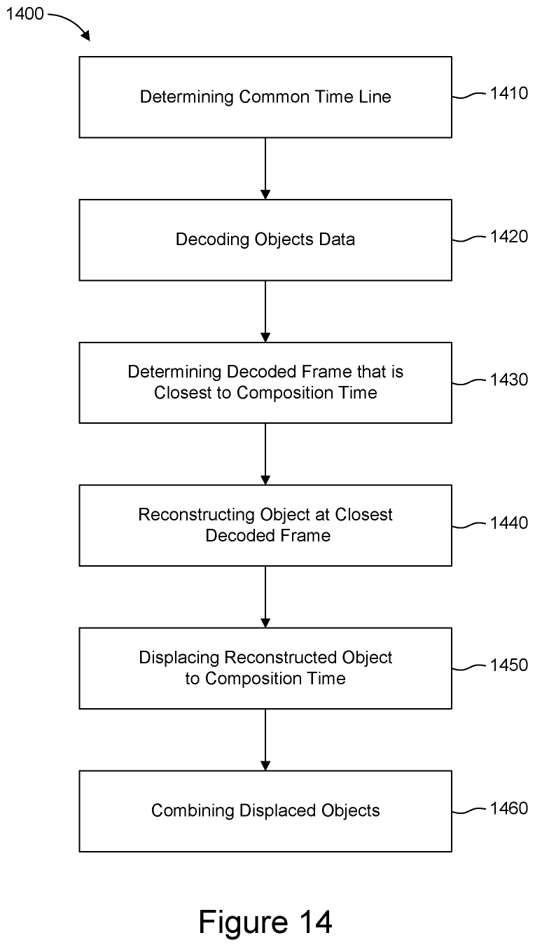

FIG. 14 shows an example of a method 1400 for reconstructing a 3D scene having a plurality of 3D objects encoded at different frame-rates in separate sub-streams, according to an embodiment. At 1410, a common timeline is determined for the 3D scene. For instance, the object encoded with the highest frame rate is selected, or a desired frame rate is selected depending on the application. At 1420, each object sub-bitstream is decoded. The sub-bitstream comprises coded data for the object as well as 3D motion information for the object.

For each time sample T of the common time line, and for each decoded object sub-bitstream, the following steps are performed:
At 1430, the closest decoded frame (time T+δt) is determined.
At 1440, the corresponding point cloud of the 3D scene part is then reconstructed with the determined decoded frame (at time T+δt),
At 1450, the 3D points of the corresponding reconstructed point cloud are displaced to their position at time T along their 3D motion direction, using the 3D motion information decoded from the sub-bitstream.

At 1460, the time aligned point cloud sequences are combined into a single 3D scene point cloud. The combined 3D scene is then available for any further application processing such as virtual viewport rendering for 6DoF navigation.

### 3D Motion Attribute

In an embodiment, the 3D motion information is encoded as a 3D motion attribute video sub-stream. For this, a new attribute is specified in V3C to carry the 3D motion information. Table 1 below in the V3C specification is modified, e.g. as follows (modifications are shown as underlined):

TABLE 1
V3C attribute types

| ai_attribute_type_id[ | | |
|---|---|---|
| j ][ i ] | Identifier | Attribute type |
| 0 | ATTR_TEXTURE | Texture |
| 1 | ATTR_MATERIAL_ID | Material ID |
| 2 | ATTR_TRANSPARENCY | Transparency |
| 3 | ATTR_REFLECTANCE | Reflectance |
| 4 | ATTR_NORMAL | Normals |
| 5 | ATTR_3D_MOTION | 3D Motion |
| 6 . . . 14 | ATTR_RESERVED | Reserved |
| 15 | ATTR_UNSPECIFIED | Unspecified |

ATTR_3D_MOTION indicates an attribute that contains a three-dimensional vector information associated with each point in a volumetric frame. The vector specifies the 3D motion of the point expressed in scene units per time units. An attribute frame with this attribute type shall have ai_attribute_dimension_minus1 equal to 2.

Miv Bitstream with 3D Motion Attribute

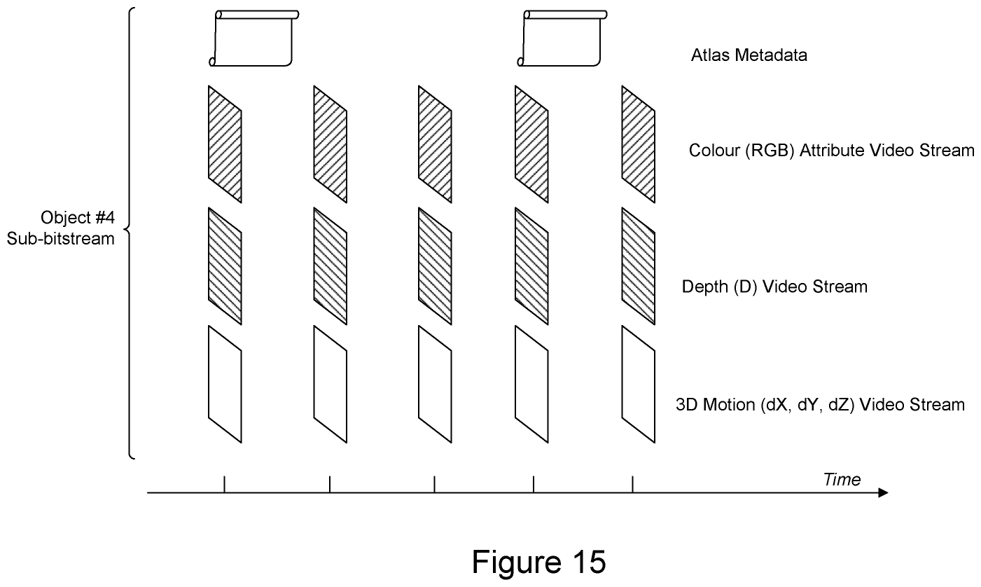

Each object composing the scene is independently encoded in an MIV sub-bitstream composed of depth, colour and 3D motion video bitstreams, associated with atlas metadata, as illustrated in FIG. 15.

### 3D Motion Modelling

In an embodiment, the 3D motion information is encoded as motion model parameters per patch of the atlas-patch based representation.

If a 3D patch can be approximated by a rigid 3D surface element, a 6-dimensional motion model consisting of a 3D translation and a 3D rotation (the origin being the patch center) can be used to describe the 3D motion of all samples of the patch. The 3 coefficients of the translation and the 3 coefficients of the rotation are then estimated from the 3D displacement vectors of the points belonging to the patch.

If the bit-rate demanding 3D motion attribute video bitstream is replaced by 3D motion parameters attached to the patches, such a motion model should be valid for all patches and for the patch lifetime (typically a 32-frame patch duration, corresponding to a video intra-period as implemented in the reference MIV encoder “Test Model 11 for MPEG Immersive Video”, ISO/IEC JTC 1/SC 29/WG 4 N00142, October 2021 may be too long). If the rigid motion model assumption is valid, however, the 3D motion attribute can then be replaced by additional syntax elements to the MIV extension of the atlas sequence parameter set and the patch data unit (as shown underlined in the tables below).

| | Descriptor |
|---|---|
| asps_miv_extension( ) { | |
| asme_ancillary_atlas_flag | u(1) |
| asme_embedded_occupancy_enabled_flag | u(1) |
| if( asme_embedded_occupancy_enabled_flag ) | |
| asme_depth_occ_threshold_flag | u(1) |
| asme_geometry_scale_enabled_flag | u(1) |
| if( asme_geometry_scale_enabled_flag ) { | |
| asme_geometry_scale_factor_x_minus1 | ue(v) |
| asme_geometry_scale_factor_y_minus1 | ue(v) |
| } | |
| if( !asme_embedded_occupancy_enabled_flag ) | |
| asme_occupancy_scale_enabled_flag | u(1) |
| if( !asme_embedded_occupancy_enabled_flag && asme_occupancy_scale_{—} | |
| enabled_flag ) { | |
| asme_occupancy_scale_factor_x_minus1 | ue(v) |
| asme_occupancy_scale_factor_y_minus1 | ue(v) |
| } | |
| asme_patch_constant_depth_flag | u(1) |
| asme_patch_texture_offset_enabled_flag | u(1) |
| if( asme_patch_texture_offset_enabled_flag ) | |
| asme_patch_texture_offset_bit_depth_minus1 | ue(v) |
| asme_max_entity_id | ue(v) |
| asme_inpaint_enabled_flag | u(1) |
| asme_3d_motion_present_flag | u(1) |
| } | |

asme_3d_motion_present_flag equal to 1 specifies that the 3D motion parameters syntax elements are present in the pdu_miv_extension ( ) syntax structure. asme_3d_motion_present_flag equal to 0 specifies that the 3D motion parameters syntax elements are not present in the pdu_miv_extension ( ) syntax structure. When not present, the value of asme_3d_motion_present_flag is inferred to be equal to 0.

| | Descriptor |
|---|---|
| pdu_miv_extension( tileID, p ) { | |
| if( asme_max_entity_id > 0 ) | |
| pdu_entity_id[ tileID ][ p ] | u(v) |
| if( asme_depth_occ_threshold_flag ) | |
| pdu_depth_occ_threshold[ tileID ][ p ] | u(v) |
| if( asme_patch_texture_offset_enabled_flag ) | |
| for( c = 0; c < 3; c++ ) { | |
| pdu_texture_offset[ tileID ][ p ][ c ] | u(v) |
| if( asme_inpaint_enabled_flag ) | |
| pdu_inpaint_flag[ tileID ][ p ] | u(1) |
| if( asme_3d_motion_present_flag ) { | |
| pdu_trans_x[ tileID ][ p ] | fl(32 |
| | ) |
| pdu_trans_y[ tileID ][ p ] | fl(32 |
| | ) |
| pdu_trans_z[ tileID ][ p ] | fl(32 |
| | ) |
| pdu_quat_x[ tileID ][ p ] | i(32 |
| | ) |
| pdu_quat_y[ tileID ][ p ] | i(32 |
| | ) |
| pdu_quat_z[ tileID ][ p ] | i(32 |
| | ) |
| } | i(32 |
| | ) |
| } | |

pdu_trans_x specifies the x-component of the translational part of the patch 3D motion.

pdu_quat_x specifies the x-component of the rotational part of the patch 3D motion, using the quaternion representation.

and the same for y and z components.

### 3D Motion Compensation

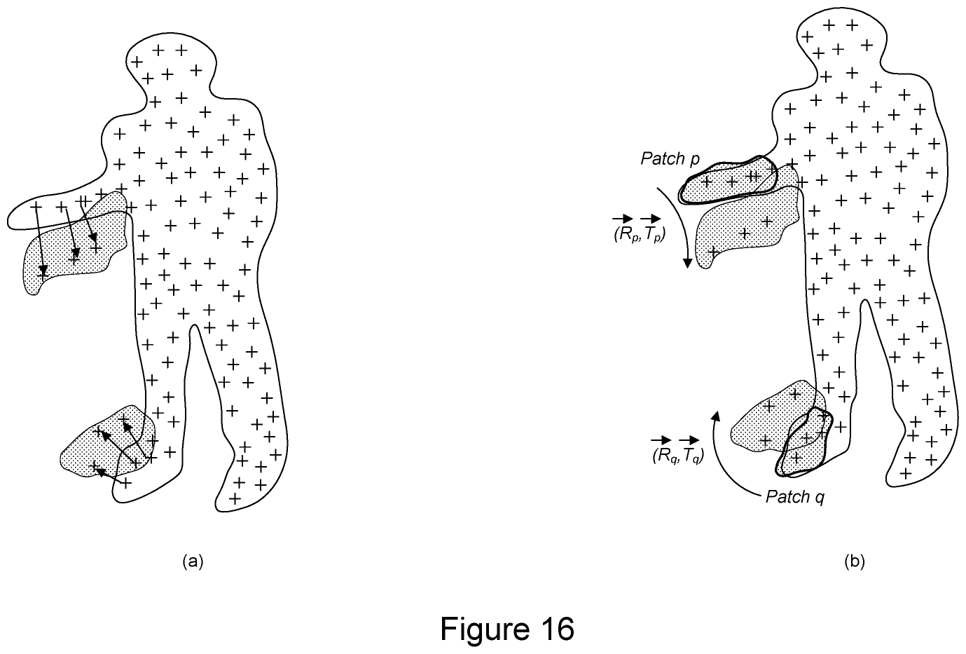

FIG. 16 depicts on the left (a) the point-based motion compensation where each point of the 3D object has a motion vector encoded in the 3D motion attribute and each point is displaced along the direction of its 3D motion attribute. On the right (b) of FIG. 16, the patch-based motion compensation is depicted where all points of a same patch follow the same motion of the patch (3D rotation and translation of the patch encoded in the patch's metadata).

### Encoding-Decoding-Alignment Workflow

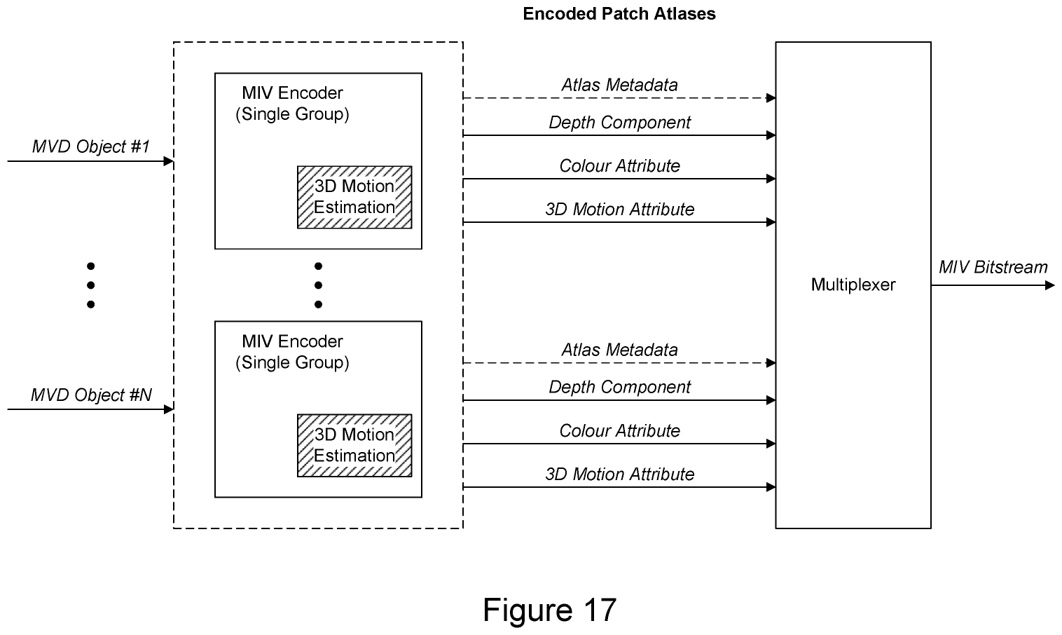

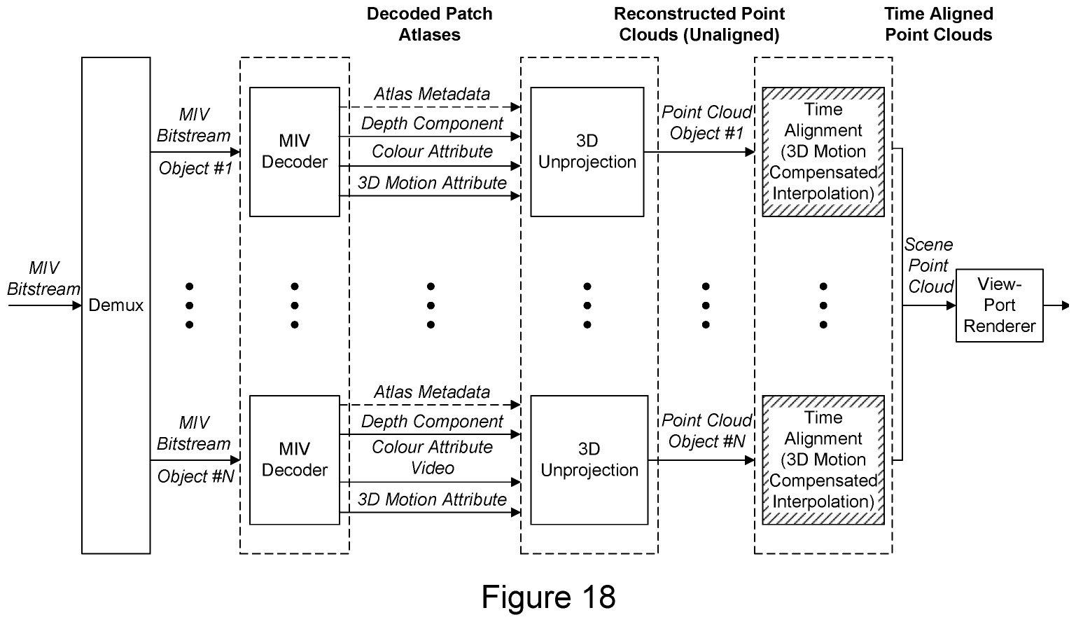

The encoding and decoding-reconstruction workflows are illustrated in FIGS. 17 and 18 respectively, for the 3D motion attribute embodiment (point-based). For the 3D motion model embodiment, there is no 3D motion attribute video bitstream but patch 3D motion parameters carried in the atlas data bitstream.

On FIG. 17, each object of the scene (MVD object #1, . . . #N) is provided to an MIV encoder which performs 3D motion estimation for the 3D points of the object. In a variant, the motion estimation is performed on the de-projected samples of the patch-atlas based representation after encoding-decoding of the patch-atlas based representation. The attributes for each object (atlas metadata, depth component, colour attribute, 3D motion attribute) are provided to a multiplexer which outputs an MIV bitstream comprising a sub-stream encoding a sequence of volumetric frames for each object.

On FIG. 18, the MIV bitstream is transmitted to the decoder wherein each MIV sub-stream of an object is provided to an MIV decoder. The MIV decoder outputs the atlas metadata, depth component, colour attribute and 3D motion attribute for the object. These data are provided to a module which performs the 3D un-projection (de-projection) of the patch-atlas based representation and outputs a reconstructed point cloud for the object.

The reconstructed point clouds of the objects may not be aligned on a same time line or may not be at a same frame rate. Thus, the time alignment module takes as inputs the reconstructed point clouds of the objects and the 3D motion information of each object and performs the temporal alignment of the objects in the 3D scene. The time alignment module uses the 3D motion information for performing 3D motion compensated interpolation for each object so that a volumetric frame at a same composition time frame is obtained for each object. Time aligned point clouds are then output.

After the reconstruction of the sequences of time aligned point clouds, virtual viewports can be rendered for 6DoF navigation, as illustrated in FIG. 18. The full original MVD sequences can also be resynthesized, and sampled at a new output frame rate. In this latter case, 3D motion compensated volumetric frame rate conversion is performed.

If the original volumetric sequence is temporally up-sampled and then played back at normal speed, then 3D motion compensated slow motion is performed.

According to the present principles, a 3D scene can be reconstructed with all object parts temporally synchronized, without judder artefacts, from a compressed representation composed of temporally unaligned object sub-bitstreams, or composed of temporally aligned sub-bitstreams but sampled at different frame rates. High-quality volumetric video frame-rate conversion and high-quality volumetric video slow motion are provided.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, Smartphones, tablets, computers, mobile phones, portable/personal digital assistants (“PDAs”), and other devices that facilitate communication of information between end-users.

Implementations of the various processes and features described herein may be embodied in a variety of different equipment or applications, particularly, for example, equipment or applications associated with data encoding, data decoding, view generation, texture processing, and other processing of images and related texture information and/or depth information. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette (“CD”), an optical disc (such as, for example, a DVD, often referred to as a digital versatile disc or a digital video disc), a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

Amendments to and listing of the claims:

1. A method comprising reconstructing at least one sequence of volumetric frames from a data stream, including:
decoding from the data stream a patch-atlas based representation of at least one volumetric frames of the sequence,
reconstructing the at least one volumetric frame using the patch-atlas based representation.
obtaining a 3D motion information representative of a displacement in a 3D space of points of the at least one volumetric frames, by decoding metadata associated to at least one patch of the patch-atlas based representation of the at least one volumetric frame, and
displacing points of the at least one volumetric frame to a composition time frame using the 3D motion information, the composition time frame being different from a time of the at least one volumetric frame encoded in the data stream.

2. An apparatus comprising one or more processors configured to reconstruct at least one sequence of volumetric frames from a data stream, which includes being configured to:
decode from the data stream a patch-atlas based representation of at least one volumetric frames of the sequence,
reconstruct the at least one volumetric frame using the patch-atlas based representation,
obtain a 3D motion information representative of a displacement in a 3D space of points of the at least one volumetric frames, by decoding metadata associated to at least one patch of the patch-atlas based representation of the at least one volumetric frame, and
displace points of the at least one volumetric frame to a composition time frame using the 3D motion information, the composition time frame being different from a time of the at least one volumetric frame encoded in the data stream.

3. The method of claim 1, wherein displacing points of the at least one volumetric frame is part of a resampling of the at least one sequence of volumetric frames at a frame rate different from the frame rate used at encoding.

4. (canceled)

5. The method of claim 1, wherein the at least one sequence of volumetric frames is representative of a three-dimensional (3D) scene comprising at least two objects encoded in separate sub-streams of the data stream.

6. The method of claim 1, wherein displacing points of the at least one volumetric frame comprises motion-compensating the decoded volumetric frame using the 3D motion information.

7. The method of claim 5, wherein each one of the at least two objects of the 3D scene is encoded as a sequence of volumetric frames.

8. (canceled)

9. The method of claim 5, wherein reconstructing the at least one sequence of volumetric frames further includes, for each object of the at least two objects, determining a time frame of the corresponding sub-stream that is closest to the composition time frame, the object of the at least two objects being decoded and reconstructed at the determined time frame.

10-13. (canceled)

14. The method of claim 1, wherein the metadata comprises parameters of a motion model determined for the at least one patch based on a 3D motion determined for de-projected samples of the at least one patch.

15. The method of claim 1, wherein at least one syntax element indicating a presence of 3D motion information is encoded in the data stream.

16. A method comprising encoding at least one sequence of volumetric frames representative of a three-dimensional (3D) scene, including:
obtaining, for at least one volumetric frame of the sequence, a patch-atlas based representation,
obtaining a 3D motion information representative of a displacement in a 3D space of de-projected samples of the patch-atlas based representation between two volumetric frames of the sequence, and
encoding in a data stream the patch-atlas based representation and the 3D motion information, the 3D motion information being encoded as metadata associated to at least one patch of the patch-atlas based representation of the at least one volumetric frame.

17. An apparatus comprising one or more processors configured to encode at least one sequence of volumetric frames, wherein the one or more processors are further configured to:
obtain, for at least one volumetric frame of the sequence, a patch-atlas based representation,
obtain a three-dimensional (3D) motion information representative of a displacement in a 3D space of de-projected samples of the patch-atlas based representation between two volumetric frames of the sequence, and
encode in a data stream the patch-atlas based representation and the 3D motion information, the 3D motion information being encoded as metadata associated to at least one patch of the patch-atlas based representation of the at least one volumetric frame.

18-21. (canceled)

22. The method of claim 16, wherein the metadata comprises parameters of a motion model determined for the at least one patch based on a 3D motion determined for de-projected samples of the at least one patch.

23. The method of claim 16, wherein at least one syntax element indicating a presence of 3D motion information is encoded in the data stream.

24. (canceled)

25. A computer readable storage medium comprising a bitstream including coded data representative of at least one sequence of volumetric frames representative of a three-dimensional (3D) scene, the coded data comprising attributes of a patch-atlas based representation obtained for the at least one sequence of volumetric frames and 3D motion information representative of a displacement in a 3D space of de-projected samples of the patch-atlas based representation between two volumetric frames of the sequence, the 3D motion information being encoded as metadata associated to at least one patch of the patch-atlas based representation of the at least one volumetric frame.

26. The computer readable storage medium of claim 25, the bitstream further comprising at least one syntax element indicating a presence of 3D motion information is encoded in the data stream.

27. (canceled)

28. A computer readable storage medium having stored thereon instructions for causing one or more processors to perform the method of claim 1.

29. A computer readable storage medium having stored thereon instructions for causing one or more processors to carry out the method of claim 1.

30. A device comprising:
an apparatus according to claim 2; and
at least one of (i) an antenna configured to receive a signal, the signal including data representative of at least one sequence of volumetric frames, (ii) a band limiter configured to limit the received signal to a band of frequencies that includes the data representative of the at least one sequence of volumetric frames, or (iii) a display configured to display the at least one sequence of volumetric frames.

31-32. (canceled)

33. The apparatus of claim 2, wherein the metadata comprises parameters of a motion model determined for the at least one patch based on a 3D motion determined for de-projected samples of the at least one patch.

34. The apparatus of claim 2, wherein at least one syntax element indicating a presence of 3D motion information is decoded from the data stream.
